(19) United States
(12) Patent Application Publication
(10) Pub. No.: US 2005/0102380 A1
(43) Pub. Date: May 12, 2005

(54) Method, system, and computer program product for theme configuration and deployment

(75) Inventor: Richard Redpath, Cary, NC (US)

Correspondence Address: SYNNESTVEDT & LECHNER, LLP, 2600 ARAMARK TOWER, 1101 MARKET STREET, PHILADELPHIA, PA, 191072950, US

(73) Assignee: International Business Machines Corporation, Armonk, NY (US)

(21) Appl. No.: 10/702,895

(22) Filed: Nov. 6, 2003

(51) Int. Cl. G06F 15/177

(52) U.S. Cl. 709/220

(57) ABSTRACT

A method, system, and computer program product enabling the configuration of network-connectable devices to display and utilize a particular theme, the specific theme to be used being designated and deployed by the network server to which the network-connectable devices connect. Each of the network-connectable devices are configured to automatically initiate a client transaction to the server (local or networked) for an HTTP GET request that contains a substitution string in the URI which identifies the request as a solicitation for a theme configuration to be deployed by the server. Upon receipt of the GET request, the server replaces the substitution string element in the URI with appropriate identification information enabling the deployment of a desired theme, background, etc. to the network-connectable device when the GET request is served.

### BACKGROUND OF THE INVENTION

1. Field of the Invention

The present invention relates to a method and system for management of enterprise criteria used by mobile employees of the enterprise. More particularly, the present invention relates to a method and system for configuring and/or creating themes for mobile client devices on a server and deploying these themes on mobile devices used by the mobile employees to thereby provide control of the look and feel of the mobile devices.

2. Description of the Related Art

The Internet and wireless communication are permanently entrenched in today's business environment. It is increasingly becoming the rule, rather than the exception, for employees to operate and conduct their business away from the traditional desk, be it in a remote location within an employee site, from their home, from their vehicle, or from a vacation site. A “mobile employee” is an employee who conducts business using networks, such as the Internet, and wired and/or wireless technology (remotely-connected devices) to remain in touch with the enterprise and/or an enterprise server belonging to the organization to which they are employed.

Server systems provide data and interactive capability for mobile employee operations for the enterprise. Mobile employees can access enterprise server resources over the Web, and more and more, mobile employees are using their mobile systems at the location of a customer, for example, in a customer support or contractor situation, or even simply in attending meetings at a customer site. “Corporate image” can be very important in such situations, and the corporation who the mobile employee is representing may wish to present a standardized “corporate image” display on the mobile devices.

The use of “themes” to create a particular “look and feel” of a computer or PDA display is well known; Windows operating systems give users the ability to set particular themes, e.g., sports themes, adventure themes, etc. so that the graphical user interface resident on the system plays various sounds, shows various images, icons, etc., all related to the theme. Frequently, the themes available to the mobile users are dictated by the particular program on the enterprise server that is delivering content to the mobile users. Thus, the themes available cannot be changed easily, i.e., they are program dependent. Further, to the extent the themes may be changed by the user locally on the mobile device, the enterprise loses control over what theme the user displays, thereby limiting the ability of the corporation to display a desired “corporate image”.

What is needed, therefore, is a way in which an enterprise may use enterprise server resources to control and implement a look and feel for themes on mobile devices accessing the enterprise server, regardless of the program or programs being served to the mobile devices by the enterprise server.

### SUMMARY OF THE INVENTION

The present invention is a method, system, and computer program product enabling the configuration of network-connectable devices to display and utilize a particular theme, the specific theme to be used being designated and deployed by the network server to which the network-connectable devices connect. Each of the network-connectable devices are configured to automatically initiate a client transaction to the server (local or networked) for an HTTP GET request that contains a substitution string in the URI which identifies the request as a solicitation for a theme configuration to be deployed by the server. Upon receipt of the GET request, the server replaces the substitution string element in the URI with appropriate identification information enabling the deployment of a desired theme, background, etc. to the network-connectable device when the GET request is served.

### BRIEF DESCRIPTION OF THE DRAWINGS

FIG. 1 illustrates a representative workstation hardware environment in which the present invention may be practiced;

FIG. 2 illustrates an exemplary data processing network in which the present invention may be practiced;

FIG. 3 illustrates a mobile device browser screen having a “golf theme” displayed in the background;

FIG. 4 is an example of a mobile device browser screen bearing a “highway theme” which shows images that are related to the work being performed by the mobile employee;

FIG. 5 shows a server 500 configured with a “properties file”; and

FIG. 6 is a flowchart illustrating the steps performed in order to change the themes in accordance with the present invention.

### DETAILED DESCRIPTION OF THE PREFERRED EMBODIMENTS

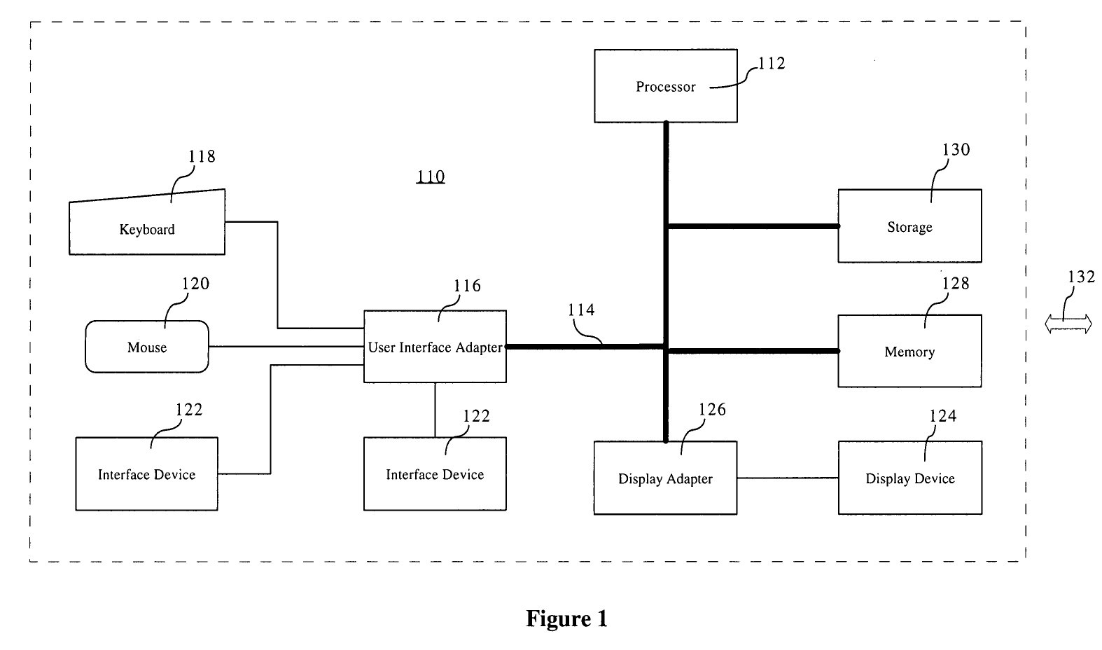

FIG. 1 illustrates a representative workstation hardware environment in which the present invention may be practiced. The environment of FIG. 1 comprises a representative single user computer workstation 110, such as a personal computer, including related peripheral devices. The workstation 110 includes a microprocessor 112 and a bus 114 employed to connect and enable communication between the microprocessor 112 and the components of the workstation 110 in accordance with known techniques. The workstation 110 typically includes a user interface adapter 116, which connects the microprocessor 112 via the bus 114 to one or more interface devices, such as keyboard 118, mouse 120, and/or other interface devices 122, which can be any user interface device, such as a touch sensitive screen, digitized entry pad, etc. The bus 114 also connects a display device 124, such as an LCD screen or monitor, to the microprocessor 112 via a display adapter 126. The bus 114 also connects the microprocessor 112 to memory 128 and long term storage 130 which can include a hard drive, tape drive, etc.

The workstation 110 communicates via a communications channel 132 with other computers or networks of computers. The workstation 110 may be associated with such other computers in a local area network (LAN) or a Wide area network, or the workstation 110 can be client in a client/server arrangement with another computer, etc. All of these configurations, as well as the appropriate communications hardware and software, are known in the art.

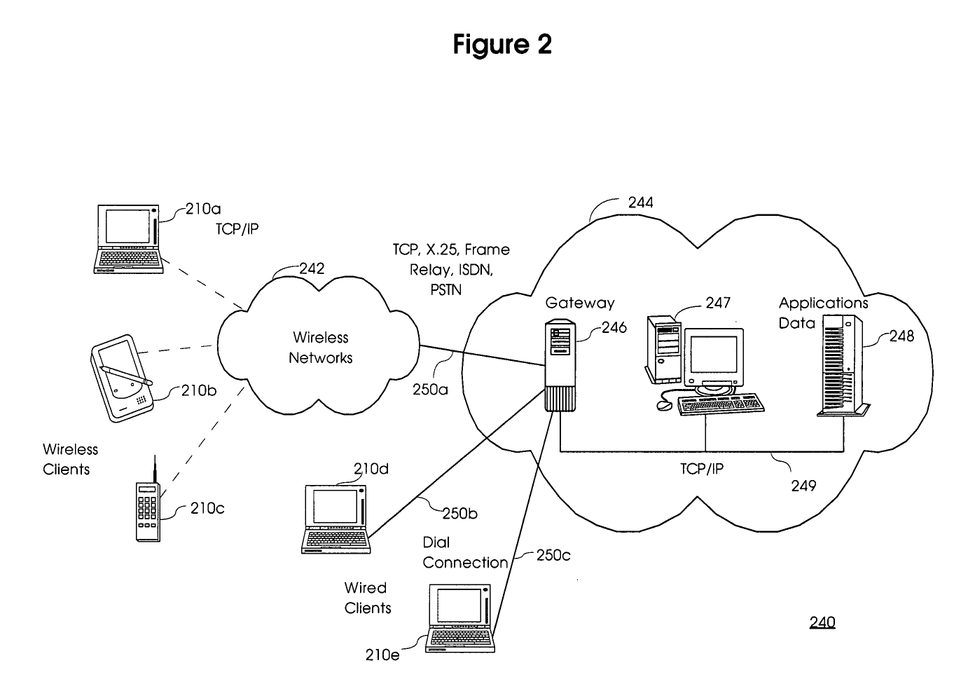

FIG. 2 illustrates an exemplary data processing network 240 in which the present invention may be practiced. The data processing network 240 may include a plurality of individual networks, such as wireless network 242 and network 244, each of which may include a plurality of individual workstations/devices, e.g. 210a, 210b, 210c. Additionally, as those skilled in the art will appreciate, one or more LANs may be included (not shown), where a LAN may comprise a plurality of intelligent workstations coupled to a host processor.

The networks 242 and 244 may also include mainframe computers or servers, such as a gateway computer 246 or application server 247 (which may access a data repository 248). A gateway computer 246 serves as a point of entry into each network 244. The gateway computer 246 may be preferably coupled to another network 242 by means of a communications link 250a. The gateway computer 246 may also be directly coupled to one or more workstations, e.g 210d, 210e using a communications link 250b, 250c. The gateway computer 246 may be implemented using any appropriate processor, such as IBM's Network Processor. For example, the gateway computer 246 may be implemented using an IBM pSeries (RS/6000) or xSeries (Netfinity) computer system, an Enterprise Systems Architecture/370 available from IBM, an Enterprise Systems Architecture/390 computer, etc. Depending on the application, a midrange computer, such as an Application System/400 (also known as an AS/400) may be employed. (“Enterprise Systems Architecture/370” is a trademark of IBM; “Enterprise Systems Architecture/390”, “Application System/400”, and “AS/400” are registered trademarks of IBM.) These are merely representative types of computers with which the present invention may be used.

The gateway computer 246 may also be coupled 249 to a storage device (such as data repository 248). Further, the gateway 246 may be directly or indirectly coupled to one or more workstations/devices 210d, 210e, and servers such as application server 247.

Those skilled in the art will appreciate that the gateway computer 246 may be located a great geographic distance from the network 242, and similarly, the workstations/devices may be located a substantial distance from the networks 242 and 244. For example, the network 242 may be located in California, while the gateway 246 may be located in Texas, and one or more of the workstations/devices 210 may be located in New York. The workstations/devices 210 may connect to the wireless network 242 using a networking protocol such as the Transmission Control Protocol/Internet Protocol (“TCP/IP”) over a number of alternative connection media, such as cellular phone, radio frequency networks, satellite networks, etc. The wireless network 242 preferably connects to the gateway 246 using a network connection 250a such as TCP or UDP (User Datagram Protocol) over IP, X.25, Frame Relay, ISDN (Integrated Services Digital Network), PSTN (Public Switched Telephone Network), etc. The workstations/devices 210 may alternatively connect directly to the gateway 246 using dial connections 250b or 250c. Further, the wireless network 242 and network 244 may connect to one or more other networks (not shown), in an analogous manner to that depicted in FIG. 2.

The present invention may be used on a client computer or server in a networking environment, or on a standalone workstation (for example, to prepare a file or to process a file which has been received over a network connection, via a removable storage medium, etc.). References herein to client and server devices are for purposes of illustration and not of limitation: the present invention may also be used advantageously with other networking models. When used in a networking environment, the client and server devices may be connected using a wired connection or a wireless connection. Wired connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The workstation or client computer may be any type of computer processor, including laptop, handheld or mobile computers; vehicle-mounted devices; desktop computers; mainframe computers; etc., having processing (and, optionally, communication) capabilities. The server, similarly, can be one of any number of different types of computer which have processing and communication capabilities. These techniques are well known in the art, and the hardware devices and software which enable their use are readily available.

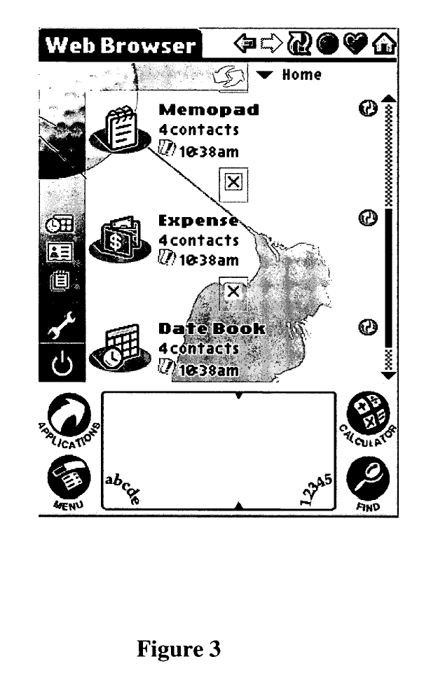

FIG. 3 illustrates a mobile device browser screen having a “golf theme” displayed in the background. In prior art systems, this theme could be selected from a menu of a program stored on the mobile device, typically the browser program. Suppose, however, the mobile device is owned by a state highway department and is used by a mobile employee at a customer work site or other location at which members of the public might be able to view the browser screen of the mobile device. To present a professional image, the highway department may not wish their employees to be using mobile devices for work-related tasks which display a golf theme, or other potentially embarrassing themes.

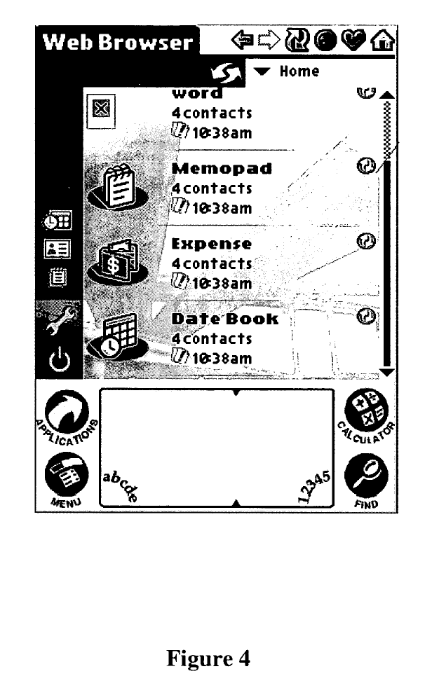

FIG. 4 is an example of a mobile device browser screen bearing a “highway theme” which shows images that are related to the work being performed by the mobile employee. Obviously these images are given simply for example and any theme that is desired to be displayed by an enterprise could be shown. In this example, the highway theme is shown as an example of a theme which a highway department might want to be used by all of its mobile employees.

So that the enterprise can control what theme is used by users of their mobile devices, the present invention allows selection of the theme to be displayed by delivering, automatically, instructions directing deployment of a particular theme, and the resources required to display the theme, to the mobile device when the mobile device is connected to the enterprise server.

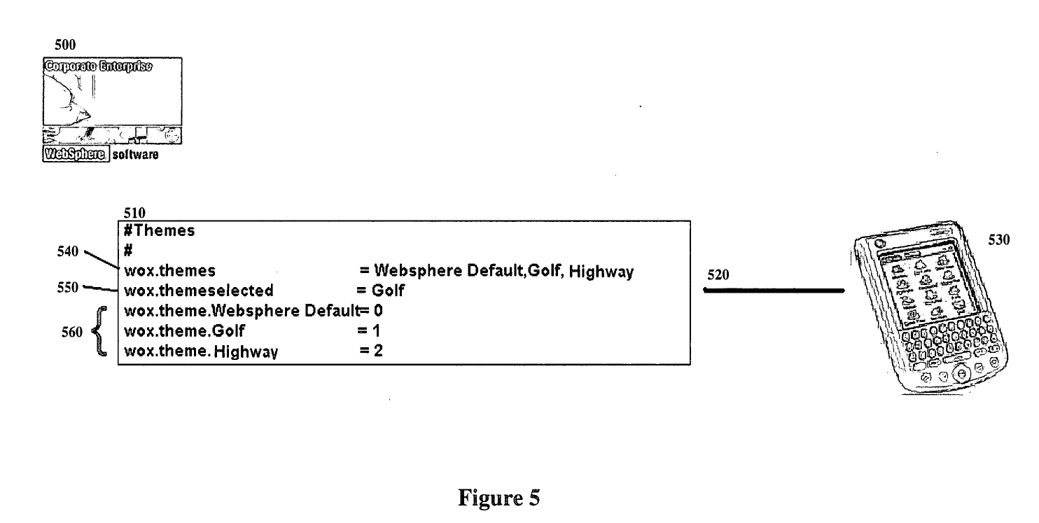

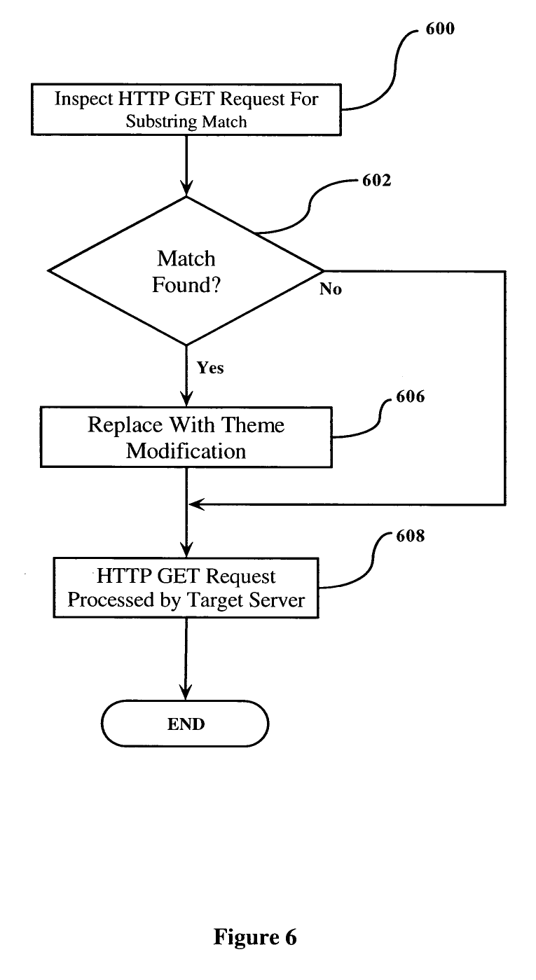

FIGS. 5 and 6 illustrate a process utilized to configure/manage the client device for a particular set of themes and the selected theme for display. FIG. 5 shows an enterprise server 500 configured with a “properties file” 510. A mobile device, PDA 530, connects to the enterprise server 500 and thus receives properties file 510 when making a connection to enterprise server 500. The PDA 530 in this example includes a local HTTP server that interprets the properties file 510 in a known manner to direct the operations of the local HTTP server. In this configuration, the HTTP server is referred to as being “resident locally with respect to” the PDA 530. Alternatively, the HTTP server can be resident locally with respect to the enterprise server 500, i.e., on the same machine as, or integrated with, the enterprise server 500.

The properties file 510 contains information which directs the trans-coding process of string substitution for the invention. The properties file 510, named “Themes” includes line 540 which is a list of the available themes, by name (e.g., “WebSphere default”, “Golf”, and “Highway”).

Line 550 states which of the three themes (in this example) has been selected for use by the PDA 530. In this example, the Golf theme has been selected for use, corresponding to the theme illustrated in FIG. 3.

A line grouping identified collectively as lines 560 are index numbered definitions of each available theme, by name. As can be seen, the WebSphere default theme is indexed by index number 0; the Golf theme is indexed by index number 1, and the Highway theme is indexed by index number 2.

In accordance with the present invention, all theme images are given a property name, e.g., “IBMTHXXXNAME.gif, where XXX can be a number. Thus, the “match mask” is essentially IBMTHXXX, and a substitution string which identifies the number to be assigned for the XXX element will identify the theme desired to be used.

For the purpose of the present invention all HTML GET requests which will identify the background to be used will be, by default, given theme name “background” and a match string of “ibmth0”, which results in an identification string “ibmth0background.gif”. The HTML for this would be as follows:
<body background=ibmth0background.gif>

Alternatively, the “ibmth0” could be “ibmth55” or “ibmth1”, etc. The match process, described below doesn't “care” what number follows the “ibmth”, since it will be replaced.

The browser in PDA 530 will perform a GET request which appears as follows:
GET/ibmth0background.gif
and this is matched with the match mask IBMTHXXX, where XXX is a number. In the example of FIG. 5, the property listed at 550, wox.themeselected=golf, results in the replacement of ibmthx with “ibmth1” (since Golf=number 1). This will change the body background tag from <body background=ibmth0background.gif> to <body background=ibmth1background.gif>. If the enterprise decides that it wishes to change the theme being used from “Golf” to “Highway” (theme number 2) the properties file 510 is simply changed so that line 550 reads “wox.themeselected=highway” and the match mask (substring) IBMTHXXX will change to “ibmth2”, thereby changing the body background line tag to <body background=ibmth2background.gif>.

A user of PDA 530 connects to enterprise server 500 (via direct network connection, wireless connection, etc.) to fetch a request, particularly an HTTP GET request. An HTTP GET request is the word GET followed by a URI. The URI is inspected by the server for a string match for a substitution and then processed by the server to deliver the contents for the URI. As a result, the PDA 530 can make a request for a theme image using a generic “template” ibmthxxx, and the enterprise server 500 can change the URI to reference the configured theme image as the content to fetch and return, i.e., the enterprise server 500 can switch from Golf to Highway as discussed above. The application producing the selected theme look is executed on the device or on a browser resident on the device. The application or browser uses HTTP to communicate to the local HTTP server on the device. All GET HTTP requests are processed by the local server which is directed by the properties file to perform URI string substitution before returning the requested document. Through this string substitution the requested document will correspond to the theme selection defined in the properties file. Through this process the enterprise server administrator can configure the mobile devices for the appropriate theme.

FIG. 6 is a flowchart illustrating the steps performed in order to change the themes (where appropriate) in accordance with the present invention. At step 600, the HTTP GET request coming from a device to the server is inspected for a substring match. In this example, a substring match occurs whenever the substring “ibmth”, followed by a number, is found, and the number is a number different from the previously loaded theme number. For example, a GET request may include instructions to fetch different information to dislay on the screen of the PDA, but make no change to the theme; in such a case, the theme number in the substring will be the same as in the previous GET request.

If a match is found at step 602, then, at step 606, the theme is identified in the substring (e.g., for ibmth2, the Highway theme) and then the HTTP GET request is processed by the local server (step 610) and the process ends. If, at step 602, no match is found in the substring, (e.g., the phrase “ibmth” is found but not followed by any number, or followed by the same number as is currently loaded) then the process proceeds directly to step 608 where the HTTP GET request is processed. In other words, there is no theme to replace in this example, so the rest of the GET request (if any) is processed.

Using the above-described steps, an enterprise server can control the theme very easily that is displayed on the mobile devices being used by its employees. The theme can be easily changed at the enterprise server for all devices connected thereto with little administration time required.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage, such as permanent storage of an enterprise server and/or on a device connectable to the enterprise server. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the appended Figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A method for controlling, from an HTTP server, a theme to be used by a device accessing the HTTP server, comprising the steps of:
receiving, by said HTTP server, a substitution string from said device; and
delivering a theme identifier to said device by replacing said substitution string with a theme identification string and sending applicable theme data, corresponding to said theme identification string, to said device.

2. The method of claim 1, wherein said step of delivering a theme identifier includes at least the step of:
delivering a properties file to said device from a central server accessible by said device, said properties file including said theme identification string.

3. The method of claim 2, wherein said properties file further includes:
multiple theme images for use by said device, wherein said theme identification string identifies one of said multiple theme images for use by said devices.

4. The method of claim 3, wherein said HTTP server is resident locally with respect to said central server.

5. The method of claim 4, wherein said HTTP server is integrated into said central server.

6. The method of claim 3, wherein said HTTP server is resident locally with respect to said device.

7. A system for controlling, from an HTTP server, a theme to be used by a device accessing the HTTP server, comprising:
means for receiving, by said HTTP server, a substitution string from said device; and
means for delivering a theme identifier to said device, comprising
means for replacing said substitution string with a theme identification string; and
means for sending applicable theme data, corresponding to said theme identification string, to said device.

8. The system of claim 7, wherein said means for delivering a theme identifier further includes:
means for delivering a properties file to said device from a central server accessible by said device, said properties file including said theme identification string.

9. The system of claim 8, wherein said properties file further include multiple theme images for use by said device, wherein said theme identification string identifies one of said multiple theme images for use by said devices.

10. The system of claim 9, wherein said HTTP server is resident locally with respect to said central server.

11. The system of claim 10, wherein said HTTP server is integrated into said central server.

12. The system of claim 9, wherein said HTTP server is resident locally with respect to said device.

13. A computer program product recorded on computer-readable medium for controlling, from an HTTP server, a theme to be used by a device accessing the HTTP server, comprising:
computer-readable means for receiving, by said HTTP server, a substitution string from said device; and
computer-readable means for delivering a theme identifier to said device, comprising
computer-readable means for replacing said substitution string with a theme identification string; and
computer-readable means for sending applicable theme data, corresponding to said theme identification string, to said device.

14. The program product of claim 13, wherein said means for delivering a theme identifier further includes:
computer-readable means for delivering a properties file to said device from a central server accessible by said device, said properties file including said theme identification string.

15. The program product of claim 14, wherein said properties file further include multiple theme images for use by said device, wherein said theme identification string identifies one of said multiple theme images for use by said device.

16. The program product of claim 15, wherein said HTTP server is resident locally with respect to said central server.

17. The program product of claim 16, wherein said HTTP server is integrated into said central server.

18. The system of claim 15, wherein said HTTP server is resident locally with respect to said device.
